(19) United States
(12) Patent Application Publication
(10) Pub. No.: US 2024/0281679 A1
(43) Pub. Date: Aug. 22, 2024

(54) MODEL GENERATION ASSISTANCE DEVICE, MODEL GENERATION ASSISTANCE METHOD, AND PROGRAM

(71) Applicant: NEC Corporation, Minato-ku, Tokyo (JP)

(72) Inventors: Etsuko ICHIHARA, Tokyo (JP); Yoshiaki SAKAE, Tokyo (JP); Hiroki TAGATO, Tokyo (JP); Takashi KONASHI, Tokyo (JP); Jun NISHIOKA, Tokyo (JP); Yuji KOBAYASHI, Tokyo (JP); Jun KODAMA, Tokyo (JP)

(73) Assignee: NEC Corporation, Minato-ku, Tokyo (JP)

(21) Appl. No.: 18/568,348

(22) PCT Filed: Jun. 15, 2021
(86) PCT No.: PCT/JP2021/022691

§ 371 Date: Dec. 8, 2023

(51) Int. Cl. G06N 5/04; G06N 20/00

(52) U.S. Cl. CPC G06N 5/04; G06N 20/00

(57) ABSTRACT

In order to attain the object of providing a technique that allows a process of constructing a model to be presented in an easily understandable manner, a model generation assistance apparatus includes: an acquisition section that acquires trial information including a parameter used in a trial in a process of constructing an AI model; an inference section that infers association between a plurality of trials on the basis of a difference between respective pieces of trial information of the plurality of trials; and an output section that outputs display data including (i) a plurality of nodes respectively representing the plurality of trials and (ii) a link representing the association.

### TECHNICAL FIELD

The present invention relates to a model generation assistance apparatus, a model generation assistance method, and a program.

### BACKGROUND ART

Prediction of various events on the basis of a prediction model has been conducted in recent years. For example, Patent Literature 1 discloses a computer system that presents a prediction result outputted from a prediction model and a decision logic indicative of prediction logic of the prediction model.

Further, for example, Patent Literature 2 discloses a learning model selection system which, at a stage where training data to be analyzed is very small, constructs a prediction model with use of training data to be analyzed and similar training data, and which, at a stage where learning data to be analyzed has sufficiently been accumulated, constructs a prediction model with use of only the learning data to be analyzed.

### CITATION LIST

### Patent Literature

Patent Literature 1
Japanese Patent Application Publication, Tokukai, No. 2020-126510
[Patent Literature 2] International Publication No. 2015/146026

### SUMMARY OF INVENTION

### Technical Problem

Note here that in a process of constructing a prediction model with higher accuracy, construction of a prediction model is repeated while changing a construction condition and the like. This process of construction may be useful in constructing other prediction models. Further, the process of construction may be presented as a basis for indicating that the prediction model has a good performance. However, with the techniques disclosed in Patent Literatures 1 and 2, it is difficult to understand what process has been taken to construct a prediction model, and it is thus difficult to assist generation of a model.

An example aspect of the present invention has been made in view of the above problem, and an example object thereof is to provide a technique for assisting generation of a model by presenting a process of constructing a model in a more easily understandable manner.

### Solution to Problem

A model generation assistance apparatus in accordance with an example aspect of the present invention includes: an acquisition means that acquires trial information including a parameter used in a trial in a process of constructing an AI model; an inference means that infers association between a plurality of trials on the basis of a difference between respective pieces of trial information of the plurality of trials; and an output means that outputs display data including (i) a plurality of nodes respectively representing the plurality of trials and (ii) a link representing the association.

A model generation assistance method in accordance with an example aspect of the present invention includes: acquiring, by at least one processor, trial information including a parameter used in a trial in a process of constructing an AI model; inferring, by the at least one processor, association between a plurality of trials on the basis of a difference between respective pieces of trial information of the plurality of trials; and outputting, by the at least one processor, display data including (i) a plurality of nodes respectively representing the plurality of trials and (ii) a link representing the association.

A program in accordance with an example aspect of the present invention causes a computer to carry out: an acquisition process of acquiring trial information including a parameter used in a trial in a process of constructing an AI model; an inference process of inferring association between a plurality of trials on the basis of a difference between respective pieces of trial information of the plurality of trials; and an output process of outputting display data including (i) a plurality of nodes respectively representing the plurality of trials and (ii) a link representing the association.

### Advantageous Effects of Invention

An example aspect of the present invention makes it possible to assist generation of a model by presenting a process of constructing a model in a more easily understandable manner.

### BRIEF DESCRIPTION OF DRAWINGS

FIG. 1 is a block diagram illustrating a configuration of an information processing apparatus in accordance with a first example embodiment of the present invention.

FIG. 2 is an example of display elements of nodes and links outputted by an information processing apparatus in accordance with the first example embodiment.

FIG. 3 is a flowchart showing a flow of an information processing method S1 in accordance with the first example embodiment.

FIG. 4 is a block diagram illustrating a configuration of an information processing system in accordance with a second example embodiment of the present invention.

FIG. 5 is a conceptual diagram showing a flow of a process of a single trial carried out by a user.

FIG. 6 is an example of input data and parameter data inputted to a model construction apparatus in accordance with the second example embodiment.

FIG. 7 is an example illustrating a part of a trial information table of all pieces of trial information recorded in a database.

FIG. 8 is an example of a trial information table acquired by an information processing apparatus in accordance with the second example embodiment.

FIG. 9 is an example of inference data in which the information processing apparatus in accordance with the second example embodiment infers association between trials.

FIG. 10 is an example of display data generated and outputted by the information processing apparatus in accordance with the second example embodiment.

FIG. 11 is an example of a color density table including a color density of a node representing each trial, the color density being inferred by an information processing apparatus in accordance with a third example embodiment.

FIG. 12 is an example of a thickness table including a thickness of a link connecting nodes to each other, the thickness being inferred by the information processing apparatus in accordance with the third example embodiment.

FIG. 13 is an example of display data outputted by the information processing apparatus in accordance with the third example embodiment, in which display data a color density of a node and a thickness of a link are displayed in an emphasized manner on the basis of a loss value.

FIG. 14 is an example of display data in accordance with another example aspect outputted by the information processing apparatus in accordance with the third example embodiment.

FIG. 15 is an example of display data in accordance with another example aspect outputted by the information processing apparatus in accordance with the third example embodiment.

FIG. 16 is an example of display data in accordance with another example aspect outputted by the information processing apparatus in accordance with the third example embodiment.

FIG. 17 is an example of display data in accordance with another example aspect outputted by the information processing apparatus in accordance with the third example embodiment.

FIG. 18 is a diagram of configuration of sections by software.

### EXAMPLE EMBODIMENTS

### First example embodiment

A first example embodiment of the present invention will be described in detail with reference to the drawings. The present example embodiment is an embodiment serving as a basis for example embodiments described later.

### (Configuration of Information Processing Apparatus)

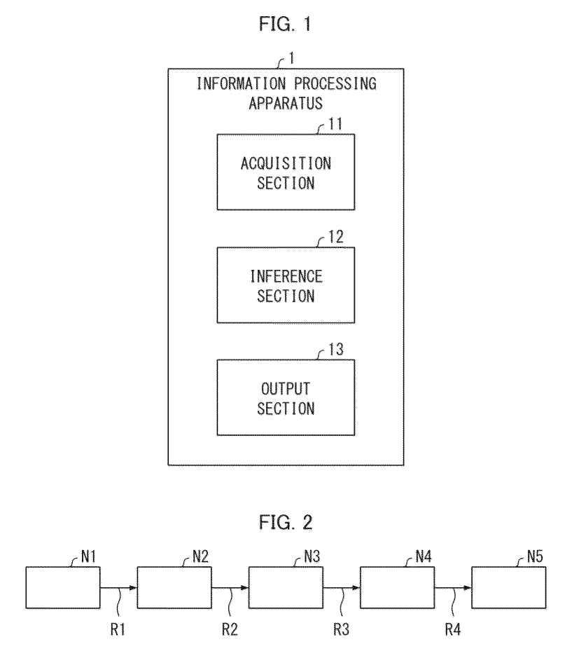

The following will discuss a configuration of an information processing apparatus 1 in accordance with the present example embodiment, with reference to FIG. 1. FIG. 1 is a block diagram illustrating a configuration of the information processing apparatus 1. The information processing apparatus 1 is an apparatus which visualizes a process in which a model construction apparatus constructs a model. The model construction apparatus can be an apparatus physically separate from the information processing apparatus 1, or the model construction apparatus and the information processing apparatus 1 can be the same apparatus. Note that the information processing apparatus 1 is an example embodiment of “model generation assistance apparatus” recited in the claims.

A model in accordance with the present example embodiment outputs a result of an inference made with respect to input information. The inference made by the model is not limited to any specific one, and examples of the inference include regression, classification, prediction, optimization, and the like. In this case, the result of an inference encompasses a result of regression, a result of classification, a result of prediction, a result of optimization, and the like. The type of the model is not limited and may be, for example, a rule-based model generated with reference to background knowledge, or may be a machine learning model generated by a machine learning algorithm. The machine learning model encompasses a regression analysis model, a support vector machine, a decision tree model, a genetic algorithm model, a neural network model, and the like. Hereinafter, the model in the present example embodiment is also referred to as “artificial intelligence (AI) model”.

In the present example embodiment, repeating a trial of generating or modifying an AI model is referred to as “constructing a model”. The trial may be repeated by the model construction apparatus on the basis of a user operation, or may be repeated by the model construction apparatus without depending on the user operation. In the present example embodiment, the trial is repeated by the model construction apparatus on the basis of a user operation. Hereinafter, an AI model to be constructed may be referred to as “target model”.

As illustrated in FIG. 1, the information processing apparatus 1 includes an acquisition section 11, an inference section 12, and an output section 13. Note that the acquisition section 11 is an example embodiment of “acquisition means” recited in Claims, the inference section 12 is an example embodiment of “inference means” recited in Claims, and the output section 13 is an example embodiment of “output means” recited in Claims. The information processing apparatus 1 includes at least one processor, and the acquisition section 11, the inference section 12, and the output section 13 are an example embodiment of the feature realized by “at least one processor” recited in Claims.

The model construction apparatus carries out a plurality of trials in order to construct an AI model, on the basis of a user operation. The acquisition section 11 acquires trial information including a parameter used in a trial in a process of constructing an AI model. Hereinafter, a whole of pieces of information respectively indicating trials or individual piece of information indicative of each of the trials is also referred to as “trial information”. The trial information includes, for example, information indicative of a parameter used in the trial, an evaluation result, and the like. For example, the trial information is caused by the model construction apparatus to be stored in a database external to the information processing apparatus 1, and the acquisition section 11 acquires the trial information from the database. The acquisition section 11 transmits the obtained information to the inference section 12. Alternatively, the trial information may be stored in a memory (not illustrated) of the information processing apparatus 1, and the acquisition section 11 may acquire the trial information from the memory. Specific examples of the trial information will be described later.

The inference section 12 infers association between a plurality of trials, on the basis of a difference between respective pieces of trial information of the plurality of trials received from the acquisition section 11. The inference section 12 transmits matters related to the inferred association to the output section 13. Specific examples of a difference or change in trial information and association between trials will be described later.

The output section 13 refers to the matters related to the association received from the inference section 12, and outputs display data including: a plurality of nodes respectively representing the plurality of trials; and a link representing the association. The display data may be generated by the output section 13. The output section 13 outputs the generated display data to a display apparatus (for example, a display) via an output interface (not illustrated). Thus, the display data is displayed on the display apparatus.

A node in the present example embodiment is a display element representing a single trial, and may be displayed, for example, in a box such as a rectangle, an ellipse, or a diamond. A link is a display element that indicates association between trials, and may be displayed, for example, in the form of a line segment or an arrow connecting nodes to each other.

FIG. 2 is an example of nodes N and links R generated by the output section 13. In the example illustrated in FIG. 2, a node N1 representing a trial 1 and a node N2 representing a trial 2 are connected to each other by a link R1 which is an arrow. The fact that the node N1 and the node N2 are connected to each other by the link R1 means that the trial 1 and the trial 2 are associated with each other. Similarly, the node N2 and a node N3 are connected to each other by a link R2, the node N3 and a node N4 are connected to each other by a link R3, and the node N4 and a node N5 are connected to each other by a link R4. As described later, the display data may include, inside or near a node N, at least part of trial information corresponding to the node N. The display data may include, inside or near a link R, at least part of trial information that has changed between trials having association indicated by the link R.

A trial is a series of processes including: a process of generating a target model with use of input information set or updated by a user operation; and a process of evaluating a result of inference outputted from the target model which has been generated. Typically, this trial is repeated multiple times while all or part of the input information is changed. For example, in a case where the target model is a machine learning model, the above trial is repeatedly carried out as a learning phase. Note that “generation of a target model” encompasses: generation of a target model for the first time; and modifying a generated target model in order to adjust the performance and the like of the target model.

Note that, in FIG. 1, the acquisition section 11, the inference section 12, and the output section 13 are illustrated as being provided together in a single, physically integrally formed apparatus, but do not necessarily have to be configured in this manner. That is, these functional blocks may be provided in a distributed manner in a plurality of physically different apparatuses, and the apparatuses may be connected to each other in a wired or wireless manner so that information communication can be carried out therebetween. In addition, at least part of the functional blocks may be located in the cloud.

Note that the information processing apparatus 1 can be configured such that the information processing apparatus 1 includes at least one processor which reads a program stored in a memory (not illustrated) and functions as the acquisition section 11, the inference section 12, and the output section 13. Such a configuration will be described later.

### (Effect of Information Processing Apparatus 1)

As described above, the information processing apparatus 1 in accordance with the present example embodiment employs a configuration of including: an acquisition section that acquires trial information including a parameter used in a trial in a process of constructing an AI model; an inference section that infers association between a plurality of trials on the basis of a difference between respective pieces of trial information of the plurality of trials; and an output section that outputs display data including (i) a plurality of nodes respectively representing the plurality of trials and (ii) a link representing the association. As such, the information processing apparatus 1 in accordance with the present example embodiment allows a user to visually recognize a process of constructing an AI model, with use of nodes representing trials and a link connecting the nodes to each other. This brings about an effect of making it possible to assist generation of a model by presenting the process in a more easily understandable manner.

### (Information Processing Method)

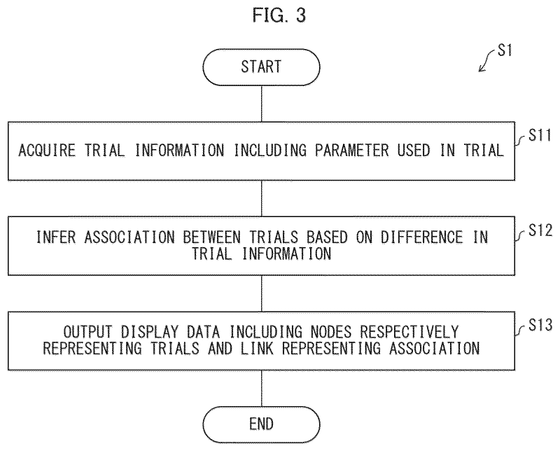

Next, the following description will discuss a flow of an information processing method S1 which is carried out by the information processing apparatus 1 and visualizes a process of constructing an AI model. FIG. 3 is a flowchart showing a flow of the information processing method S1. As illustrated in FIG. 3, the information processing method S1 includes a step S11, a step S12, and a step S13. Note that the information processing method S1 is an example embodiment of “model generation assistance method” recited in Claims.

In step S11, the acquisition section 11 acquires trial information including a parameter used in a trial in the process of constructing an AI model. In step S12, the inference section 12 infers association between a plurality of trials, on the basis of a difference between respective pieces of trial information of the plurality of trials. In step S13, the output section 13 outputs display data including: a plurality of nodes representing respective ones of the plurality of trials; and a link representing the association. The display data outputted is displayed, for example, on a display apparatus as illustrated in FIG. 2.

### (Effect of Information Processing Method S1)

As described above, the information processing method S1 in accordance with the present example embodiment employs a configuration in which the information processing apparatus 1: acquires trial information including a parameter used in a trial in a process of constructing an AI model; infers association between a plurality of trials on the basis of a difference between respective pieces of trial information of the plurality of trials; and outputs display data including (i) a plurality of nodes respectively representing the plurality of trials and (ii) a link representing the association. As such, the information processing method S1 in accordance with the present example embodiment allows a user to visually recognize a process of constructing an AI model, with use of nodes representing trials and a link connecting the nodes to each other. This brings about an effect of making it possible to assist generation of a model by presenting the process in a more easily understandable manner.

### Second Example Embodiment

The following will discuss in detail a second example embodiment of the present invention, with reference to drawings. Note that constitutional elements having the same functions as those of the constitutional elements described in the first example embodiment are denoted by the same reference signs, and descriptions thereof will be omitted as appropriate. An information processing apparatus 2 in accordance with the present example embodiment is capable of carrying out functions described below, in addition to or in place of the functions of the information processing apparatus 1 described in the first example embodiment.

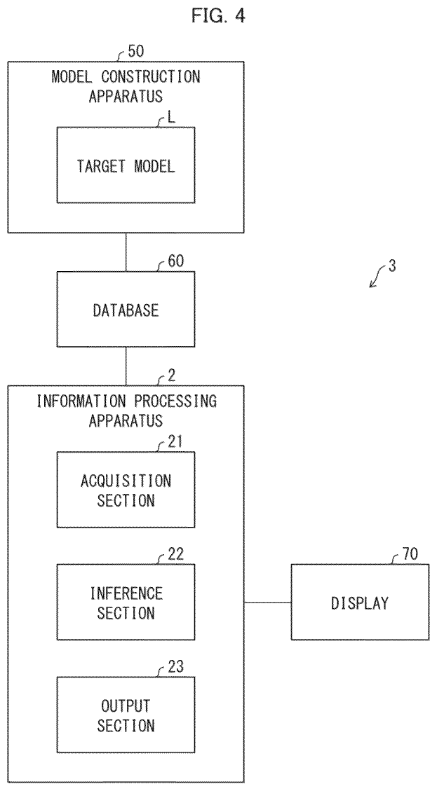

FIG. 4 is a block diagram illustrating a configuration of an information processing system 3 in accordance with the second example embodiment. As illustrated in FIG. 4, the information processing system 3 includes a model construction apparatus 50, a database 60, the information processing apparatus 2, and a display 70. The model construction apparatus 50 is an apparatus used by a user to generate a target model L. In the database 60, output information outputted by the model construction apparatus 50 at each trial is recorded. The information processing apparatus 2 infers, with use of the output information recorded in the database 60, association between a plurality of trials, generates display data, and outputs the generated data to the display 70. The display 70 displays the display data.

The information processing apparatus 2 includes an acquisition section 21, an inference section 22, and an output section 23. The functions of the acquisition section 21, the inference section 22, and the output section 23 are basically the same as those of the acquisition section 11, the inference section 12, and the output section 13 described in the first example embodiment. Functions different from these will be sequentially described.

### (Flow of Process in Trial T)

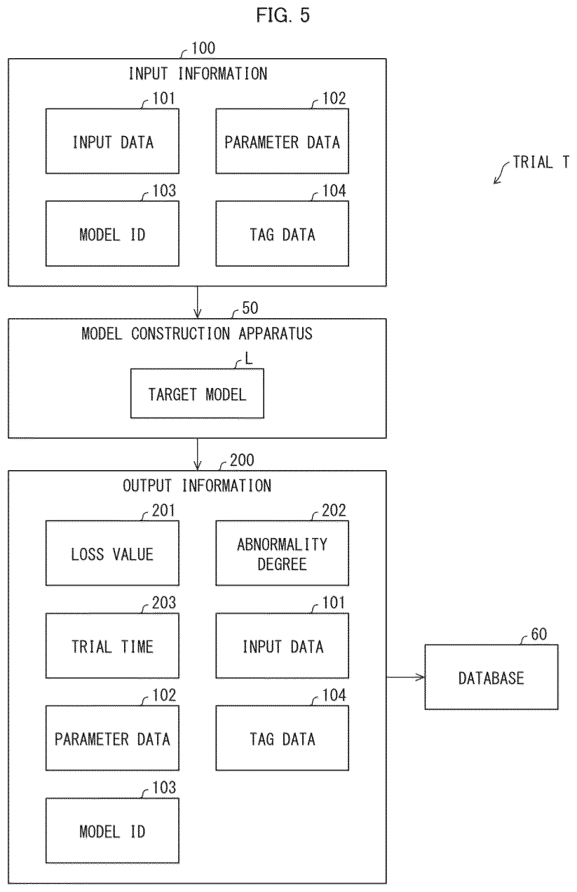

As described above, the user constructs the target model L with use of the model construction apparatus 50. FIG. 5 is a conceptual diagram illustrating a flow of a process of a single trial T carried out by the user with use of the model construction apparatus 50. As illustrated in FIG. 5, in a trial, the user inputs input information 100 to the model construction apparatus 50 with use of an input apparatus (not illustrated). The model construction apparatus 50 inputs the input information 100 to the target model L so as to cause the target model L to make an inference, and evaluates a result of the inference. Evaluating a result of inference is, for example, deriving a loss value. The model construction apparatus 50 generates output information 200 including the input information 100 and information indicative of an evaluation result. The user modifies the target model L on the basis of the output information 200 outputted from the model construction apparatus 50. Specifically, the user updates a parameter included in the target model L. On the basis of the output information 200, the user determines the input information 100 to be inputted in the next trial, and inputs the input information 100 to the model construction apparatus 50. The user may also (i) decide, on the basis of the output information 200, to change the type of the target model L and (ii) include information indicative of a type of the target model L in the input information 100.

The input information 100 includes, for example, input data 101, parameter data 102, a model ID 103, and tag data 104. The input data 101 is data that is inputted to the target model L. The input data 101 includes, for example, a label given to the input data 101. The parameter data 102 includes: a weighting factor applied to a parameter group constituting the target model L; a hyperparameter; and the like. The model ID 103 is an ID for identifying a target model L to be generated in the trial. The tag data 104 is an ID for identifying a series of trials.

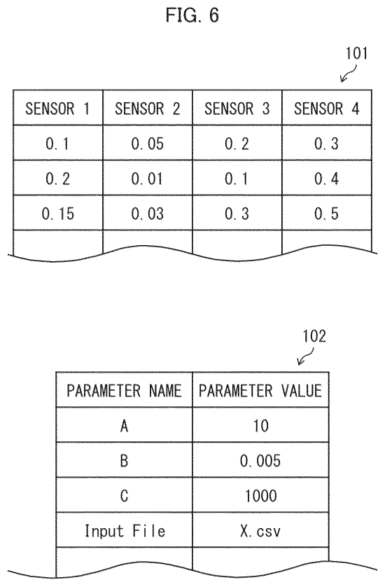

For example, as illustrated in FIG. 6, the input data 101 includes time-series data of output values of the sensor 1, the sensor 2, the sensor 3, and the sensor 4. Each row of the input data 101 has respective output values of the sensors at a certain point in time, and these output values are arranged in a chronological order. The input data 101 is stored in a data file named X.cvs. Such data is, for example, sensor data from a plant facility and is an example of input data inputted at the time of constructing a target model L for detecting an anomaly in the facility on the basis of the sensor data.

The parameter data 102, for example, includes names of four parameters and values of the four parameters. Specifically, the parameter data 102 includes a parameter A and its value 10, a parameter B and its value 0.005, a parameter C and its value 1000, and a parameter Input File (i.e., parameters representing the input data 101) and a file name “X.cvs” of that data. The data included in the file X.cvs is, for example, data obtained by subjecting raw data (output values from the sensors) to Fourier transform. In other words, in this example, the input data 101 includes a large number of pieces of data, so that the file name of the data is included as a parameter in the parameter data 102.

The parameters A to C may include, for example, weighting factors (weights) applied to the parameter group constituting the target model L, or may include a hyperparameter. For example, in a case where the target model L is a neural network model, examples of the hyperparameter include, but are not limited to, the total number of neural networks, the number of units, an activation function, a dropout rate, an optimization function, and the like.

The model construction apparatus 50 generates the target model L such that the target model L outputs a label given to the input data 101, upon receiving input of at least part of the input data 101 and the parameter data 102. For example, in a case where the target model L is a machine learning model, the process of generating the target model L is a process of repeating a process of updating a parameter group constituting the target model L. In this case, the model construction apparatus 50 repeats the process of updating the parameter group until the parameter group converges or the set number of times is reached, so that the target model L is generated.

The model construction apparatus 50 evaluates a result of inference which is outputted in a case where at least part of the input data 101 is inputted to the target model L. For example, the model construction apparatus 50 calculates, as an evaluation result, a loss value 201, an abnormality degree 202, or the like (described later).

With reference back to FIG. 5, the output information 200 outputted from the model construction apparatus 50 includes, for example, the loss value 201, the abnormality degree 202, trial time 203, the input data 101, the parameter data 102, the model ID 103, and the tag data 104.

The loss value 201 or the abnormality degree 202 is an example of an index indicative of the performance of the target model L. According to the type of the target model L, for example, either the loss value 201 or the abnormality degree 202 is outputted. The loss value 201 is an error function value which, in a case where there is a correct value to be outputted by the target model L in response to the input information, indicates an error between the output value of the target model L and the correct value. The abnormality degree 202 is a numerical value which, in a case where the target model L is an AI model that extracts abnormal data among the input data 101, indicates (i) identification of the abnormal data and (ii) a degree to which the abnormal data is different from a normal value. Alternatively, an index different from the loss value 201 or the abnormality degree 202 may be outputted according to the type of the target model L. The trial time is time at which the trial T is started, and is, for example, time at which input data is inputted to the target model L.

The input data 101, the parameter data 102, the model ID 103, and the tag data 104 are the same as the information included in the input information 100.

The output information 200 is transmitted to the database 60 and stored in the database 60 as trial information. For example, output information 200 of seven trials T1 through T7 in the process of constructing the target model L is transmitted to the database 60 and stored in the database 60 as trial information. Note that the database 60 can store therein trial information in a process of constructing another AI model. Among the trial information recorded, the trial information indicative of a series of trials in the process of constructing the target model L is distinguishable, for example, on the basis of the model ID 103 and/or the tag data 104.

The information processing apparatus 2 in accordance with the present example embodiment acquires trial information in trials T1 through T7 carried out with use of the model construction apparatus 50 and infers association between these trials. Specifically, first, the acquisition section 21 extracts (acquires), from among all of the pieces of information recorded in the database 60, pieces of trial information that are similar to one another in both model ID and tag data.

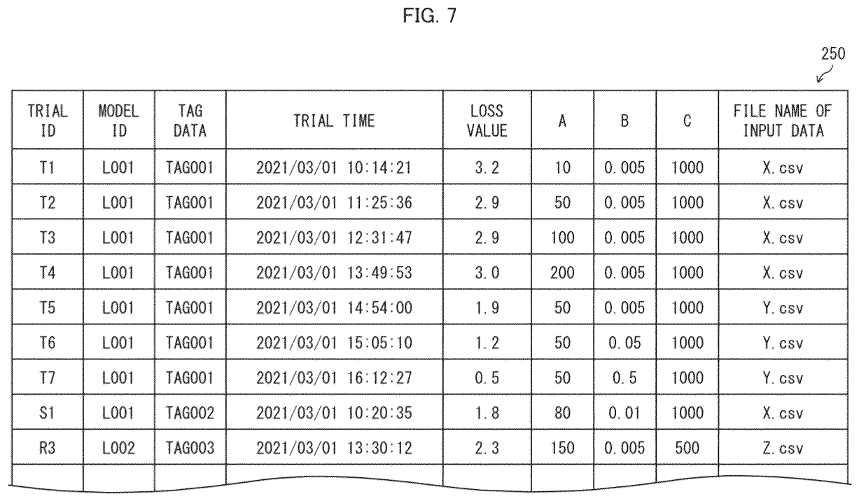

FIG. 7 is a part of a trial information table 250 in which all of the trial information recorded in the database 60 is recorded. The trial information table 250 is constituted, for example, by respective pieces of data recorded in the columns of: trial ID; model ID; tag data; trial time; loss value; parameter A; parameter B; parameter C; and file name of input data.

In FIG. 7, T1 through T7, S1, and R3 recorded in the column “trial ID” are IDs for identifying the respective trials. “L001” recorded in the column “model ID” is an ID given to the target model L. The model ID may be the same code used across a series of trials, or may be a code obtained by partially changing it for each trial. In the present example embodiment, the same sign is used across a series of trials. Hereinafter, the AI model given a model ID “L001” is also referred to as “model L001”. “TAG001” recorded in the column “tag data” is data given in common to the series of trials T1 through T7 in the process of constructing the target model L001. “TAG002” recorded in the column “tag data” is data given in common to a series of other trials including a trial S1 in the process of constructing the target model L001. In other words, in the example illustrated in FIG. 7, in order to construct the same target model L001, a series of trials T1 through T7, to which TAG001 is given, and a series of trials (including a trial S1), in which an approach different from that of TAG001 is taken, are carried out. The trial information recorded as L002 in the column “model ID” and recorded as TAG003 in the column “tag data” represents a trial R3 which has been carried out in order to construct an AI model L002 different from the target model L001.

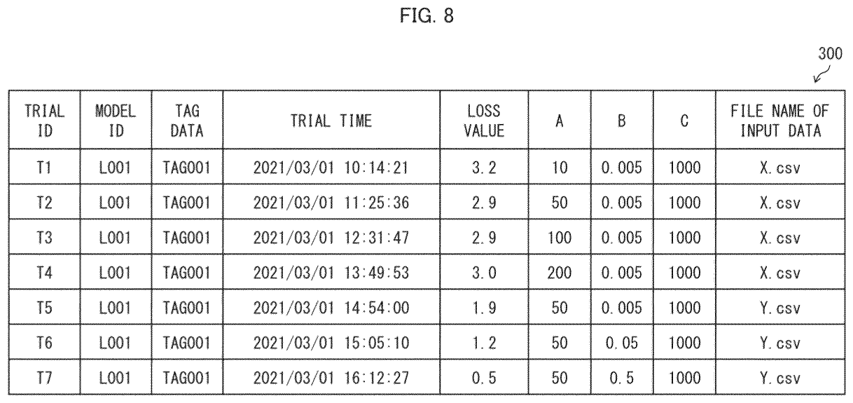

FIG. 8 is an example of a trial information table 300 in which trial information extracted by the acquisition section 21 from all of the trial information recorded in the database 60 is recorded. As described above, the acquisition section 21 extracts (acquires), from among all of the pieces of information recorded in the database 60, pieces of trial information that are similar to one another in both model ID and tag data, as in the trial information table 300. Note here that being “similar in model ID” means “having a model ID that matches (is identical)”. Alternatively, being “similar in model ID” may mean including a model ID that indicates a predetermined similarity condition. Note that being “similar in tag data” means “having tag data that matches”. Not confined to this, being “similar in tag data” may mean including tag data that indicates a predetermined similarity condition. The similarity condition may mean, for example, that part of text indicating a model ID or tag data matches. The acquisition section 21 can extract, as a series of trials in the process of constructing the target model L, a plurality of trials which are similar to one another in model ID and/or tag data.

In the present example embodiment, as illustrated in FIG. 8, the acquisition section 21 extracts the trials T1 through T7 that are identical in model ID and tag data. Note that the acquisition section 21 may extract pieces of trial information that are identical to one another in model ID and/or tag data, or extract pieces of trial information between which the model ID and/or the tag data are/is the same.

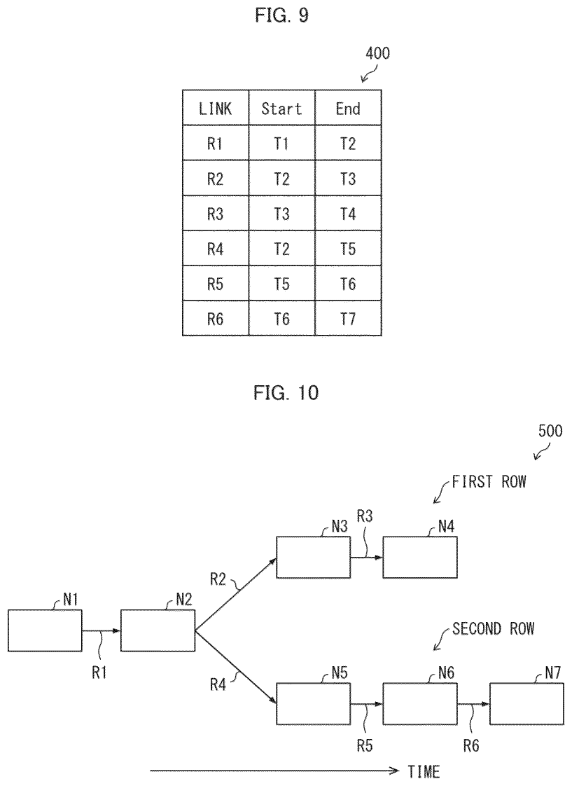

FIG. 9 is an example of an inference data table 400 in which the inference section 22 infers association between trials. Specifically, the inference section 22 infers association between two consecutive trials in a time series of a plurality of trials. For example, the trial T1 and the trial T2 are consecutive trials. Consecutive trials are trials that are adjacent to each other in a time series arranged in an order in which the plurality of trials are carried out (an order of trial start time). That is, the inference section 22 extracts, from the plurality of trials, the consecutive trials T1 and T2, and infers that there is association between the trials T1 and T2 in that the chronologically subsequent (end) trial T2 was carried out in order to modify the target model L generated by the chronologically preceding (start) trial T1.

Similarly, the inference section 22 extracts consecutive trials T2 and T3 and infers that there is association between the trials T2 and T3 in that the subsequent trial T3 was carried out in order to modify the target model L generated by the preceding trial T2. As such, the inference section 22 extracts all combinations of two consecutive trials in a time series and infers association thereof.

### (Specific Example of Inference of Association Between Trials)

The following description will discuss a specific example of an inference of association between trials carried out by the inference section 22. For example, the inference section 22 extracts, as a first group of trials associated with each other, a plurality of trials between which the first parameter is the same and the second parameter changes. The first parameter and the second parameter are examples of trial information. The second parameter is a parameter that is different in type from the first parameter. In the present example embodiment, it is assumed that the number of parameters to be changed in a subsequent trial with respect to a preceding trial is one (1), and no other parameters are changed. Note that the number of parameters to be changed may be 2 or more.

Specifically, the inference section 22 refers to the trial information table 300 illustrated in FIG. 8, and, in the example illustrated in FIG. 8, extracts, from among the trials T1 through T7, the trials T2, T3, and T4 between which the parameter B is the same and each of which has a parameter A that has changed from a parameter A of a preceding trial. The parameter B is an example of the first parameter, and the parameter A is an example of the second parameter. Thus, the inference section 22 extracts the trials T1 through T4 as a first group of trials. Then, the inference section 22 infers that the above-described association is found between the consecutive trials T1 and T2, between the consecutive trials T2 and T3, and between the consecutive trials T3 and T4, respectively, among the trials T1 through T4 extracted.

The trial information further includes a third parameter different from the first parameter and from the second parameter, and the inference section 22 extracts, as a second group of trials associated with each other, a plurality of trials between which each of the second parameter and the third parameter is the same and the first parameter changes.

Specifically, in the example illustrated in FIG. 8, in a case where the file name of input data is considered a third parameter, the value of the second parameter (A) and the value of the third parameter are each the same across the trials T5 through T7, whereas all of the respective first parameters (B) of the trials T5 through T7 are different from one another in value. Thus, the inference section 22 extracts the trials T5 through T7 as a second group of trials. Then, the inference section 22 infers that the above-described association is found between the consecutive trials T2 and T5, between the consecutive trials T5 and T6, and between the consecutive trials T6 and T7, respectively, among the trials T5 through T7 extracted. Note that the difference in file name of input data is due to a difference in data preprocessing method. In the present example embodiment, the data included in the file X.cvs is data obtained by subjecting raw data (output values from the sensors) to Fourier transform. The data included in the file Y.cvs is data obtained by subjecting raw data to polar coordinate transform.

Further, the inference section 22 identifies, as a branch point in the first group of trials, a trial in the first group of trials which trial is identical in the first parameter and the second parameter to a temporally first trial in the second group of trials.

Specifically, the inference section 22 identifies, as a branch point in the first trial group, the trial T2 in the first group of trials which trial T2 has the same first parameter (B) and the same second parameter (A) as those of a temporally first trial (the trial T5) in the second group of trials. Further, the inference section 22 causes the trial T5, which is the first one in the second group of trials, to be associated with the trial T2 with use of a link R4 which is branching off. By carrying out the above process, the inference section 22 generates the inference data table 400 illustrated in FIG. 9.

FIG. 10 is an example of display data 500 generated and outputted by the output section 23. The output section 23 refers to the inference data table 400 and generates display data including the nodes N1 to N7 and the links R1 to R6, as illustrated in FIG. 10. The nodes N1 to N7 are display elements representing the trials T1 to T7. The links R1 through R6 are display elements each of which indicates association between a corresponding set of two trials T among the trials T1 through T7. This way of illustration makes it easy to recognize that the trials T5 through T7 indicated by the second group of trials (the node N5 through the node N7) are a series of trials carried out by changing a parameter in accordance with another approach from the trial T2 indicated by the node N2 which is the branch point.

The nodes N1 to N7 are each indicated as a rectangular frame. In a case where a node is not identified, the node is indicated as a node N. In a case where a link is not identified, the link is indicated as a link R. The link R has an orientation and is, for example, represented as an arrow. Connected to a start point of the link R is a node N that represents a preceding trial T in a time series out of a corresponding set of two trials T associated with each other. Connected to an end point of the link R is a node N that represents a temporally subsequent trial T out of a corresponding set of two trials T associated with each other. Thus, the nodes N1 to N7 and the links R1 to R6 represent directed graphs. Hereinafter, a node representing a preceding trial is referred to as a preceding node, and a node representing a subsequent trial is referred to as a subsequent node.

The plurality of nodes included in the display data are arranged in an order in which the trials have been carried out. That is, the output section 23 generates display data in which the plurality of nodes N are arranged in an order in which the respective trials have been carried out. Specifically, the output section 23 generates and outputs display data 500 in which the plurality of nodes N are arranged from the left to the right in FIG. 10 in an order in which the trials have been carried out. In other words, in the display data 500, a node N representing a temporally early trial T is arranged on the left side of the link R, and a node N representing a temporally late trial T is arranged on the right side of the link R.

The output section 23 outputs, as a first row, display data including a plurality of nodes (N1 through N4) representing the first group of trials and links (R1 through R3) connecting the plurality of nodes to each other, as illustrated in FIG. 10. In so doing, the output section 23 outputs the display data in which the nodes included in the group of trials are arranged in an order in which the trials have been carried out. Further, the output section 23 outputs, as a second row, display data in which the nodes (N5 through N7) representing the second group of trials and the links (R4 through R6) are (i) branched from the node (R2) representing the trial at the branch point among the plurality of nodes representing the first group of trials and (ii) connected to each other, as illustrated in FIG. 10.

As illustrated in FIG. 10, the display data 500 is branched into the links R2 and R4 along the way. The respective rows of nodes N into which the display data 500 branches each indicate a process of investigating an effect of a different parameter on the performance of the target model L. That is, the user can easily understand the process of constructing the target model L by visually recognizing the process of constructing the target model L in a graph structure illustrated in FIG. 10.

### (Effects of Information Processing Apparatus 2)

As described above, the information processing apparatus 2 in accordance with the present example embodiment employs a configuration in which a plurality of nodes included in display data are arranged in an order in which trials have been carried out. Therefore, the information processing apparatus 2 in accordance with the present example embodiment can provide, in addition to the effects which are yielded by the information processing apparatus 1 in accordance with the first example embodiment, an effect of making it easy to understand the process over time of constructing the target model L.

Further, the information processing apparatus 2 employs a configuration in which: the inference section 22 extracts, as a first group of trials associated with each other, a plurality of trials between which the first parameter is the same and the second parameter changes; and the output section 23 outputs the display data including (i) a plurality of nodes representing the first group of trials and (ii) a link connecting the plurality of nodes to each other. Further, the information processing apparatus 2 employs a configuration in which: a third parameter different from the first parameter and from the second parameter is further included; the inference section 22 extracts, as a second group of trials associated with each other, a plurality of trials between which each of the second parameter and the third parameter is the same and the first parameter changes, and identifies, as a branch point in the first group of trials, a trial in the first group of trials which trial has the same first parameter and the same second parameter as those of a temporally first trial in the second group of trials; and the output section outputs the display data in which nodes and a link representing the second group of trials (i) branch from a node representing the trial at the branch point among the plurality of nodes representing the first group of trials and (ii) are connected to each other. Therefore, the information processing apparatus 2 in accordance with the present example embodiment can provide, in addition to the effects which are yielded by the information processing apparatus 1 in accordance with the first example embodiment, an effect of making it easy to understand a process of carrying out, in order to modify the target model L, trials while changing the input information in a respective plurality of patterns.

### Third Example Embodiment

The following will discuss in detail a third example embodiment of the present invention, with reference to drawings. Note that constitutional elements having the same functions as those of the constitutional elements described in the first example embodiment are denoted by the same reference signs, and descriptions thereof will be omitted as appropriate.

### (Configuration of Information Processing Apparatus)

An information processing apparatus 4 in accordance with the third example embodiment is an example aspect obtained by modifying the information processing apparatus 2 in accordance with the second example embodiment as follows. The following description will discuss, in turn, modifications made in functional blocks of the information processing apparatus 4 in comparison to the second example embodiment.

An acquisition section 21 of the information processing apparatus 4 acquires trial information of a series of trials from the database 60. In the present example embodiment, the series of trial information is identical to that of the trial information table 300 (see FIG. 8) described in the second example embodiment. As such, an inference section 22 generates an inference data table 400 (see FIG. 9) from the trial information table 300. The output section 23 generates display data 500 (see FIG. 10) and outputs the generated data to the display 70.

### (Display in Different Modes)

In the present example embodiment, the inference section 22 identifies, among the plurality of trials, a trial in which the performance of an AI model has improved or degraded as compared to a preceding trial associated with the trial. Further, the output section 23 outputs (i) a node representing the identified trial and/or (ii) a link connecting the node and a node representing a preceding trial to each other, in a mode different from that of other node(s) or other link(s). A different mode is, for example, a mode emphasized over others. Alternatively, a different mode can conversely be a mode less conspicuous than the others.

Specifically, the inference section 22 refers to the loss values in the trial information table 300, and identifies a subsequent node having a loss value decreased or increased from that of a preceding node among a combination of two nodes connected by a link R in the inference data table 400. The output section 23 outputs display data in which (i) the subsequent node and/or (ii) a link connecting the preceding node and the subsequent node to each other are displayed in a mode different from that of other(s).

The method by which the mode of a node or a link is made different from that of other(s) is not limited. For example, the output section 23 may cause at least one selected from the group consisting of: a color tone of the node (subsequent node) representing the identified trial; a size of the node; a shape of the node; a color tone of the link; and a thickness of the link to be different from that of other node(s) or other link(s).

For example, in order to indicate that the lower the loss value, the better the performance, the output section 23, for example, displays in an emphasized manner (i) a subsequent node having a decreased loss value and (ii) a link connecting the subsequent node and a preceding node to each other. The method of such emphasized display is not limited, but the emphasized display can be achieved, for example, by lightening the color tone of a node and increasing the thickness of a link. Conversely, the output section 23 can reduce the size of a node so that the node is less conspicuous than other nodes. In the present example embodiment, color tone means color type or color density.

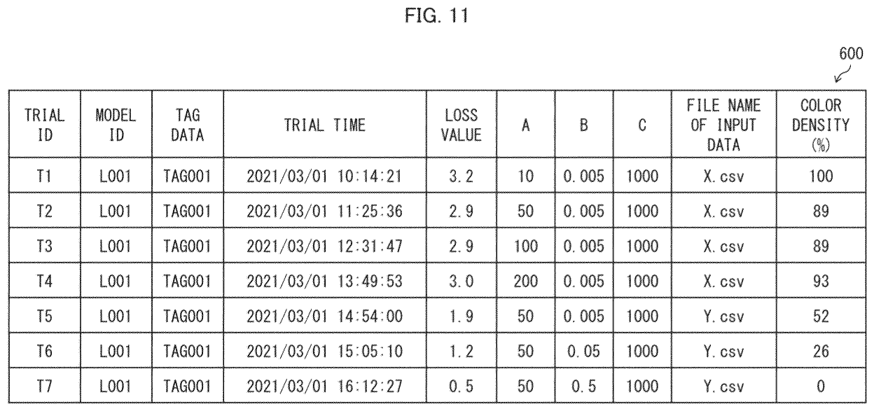

FIG. 11 is an example of a color density table 600 obtained by adding, to the trial information table 300, a color density of a node representing each trial. The column at the right end of the color density table 600 indicates a density (%) of the color of a node. The node N1 indicated by the trial ID “T1” is at the start of the trials and therefore has the highest loss value. As such, it is determined that the node N1 indicated by the trial ID “T1” is to be given a density of 100%. The output section 23 uses this as a reference to calculate a density of each node N.

A density C of each node N in the color density table 600 is a value calculated by the following expression (1).

$$C ( \% ) = 100 \times ( {Loss}_{T} - {Loss}_{min} ) / ( L o s {s}_{max} - L o s {s}_{min} ) \qquad ( 1 )$$

where Loss_{T} is a loss value of each node N, Lossₘᵢₙ is a minimum loss value, and Lossₘₐₓ is a maximum loss value. The above expression (1) is used as a calculation expression for determining that a node having a maximum loss value among the series of trials is to be given a density of 100%, and a node having a minimum loss value among the series of trials is to be given a density of 0%. That is, nodes are displayed such that the better the performance of a node, the lighter the color of the node. Note that the density of the color of a node can be determined by any method, and is not confined to the above method.

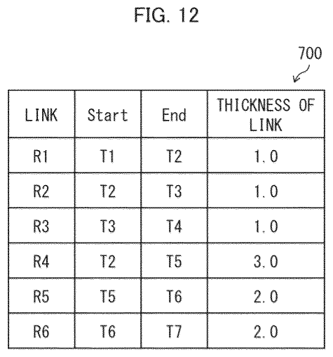

FIG. 12 is an example of a thickness table 700 indicative of a thickness of a link R connecting nodes N to each other. The thickness table 700 is a table obtained by adding, to the inference data table 400, thicknesses of links. The thickness of a link in the thickness table 700 is a value obtained on the basis of a difference in loss value between a preceding node and a subsequent node. Specifically, the loss value of the subsequent node is subtracted from the loss value of the preceding node, and in a case where a difference thereof is less than 0.5, the thickness of the link is determined to be 1.0. In a case where the difference is not less than 0.5 and less than 0.7. the thickness is determined to be 2.0. In a case where the difference is not less than 0.7, the thickness is determined to be 3.0.

For example, the link R4 from the node N2 to the node N5 has a thickness of 3.0 because the amount of reduction in loss value is 1.0, which is a significant reduction. The link R2 connecting the node N2 and the node N3 to each other, the link R3 connecting the node N3 and the node N4 to each other, and the like are each given a thickness of 1.0 due to a small decrease in loss value. The thickness can be in any unit. The thickness is increased as the reduction in loss value increases. Note that the thickness of a link can be determined by any method, and is not confined to the above method.

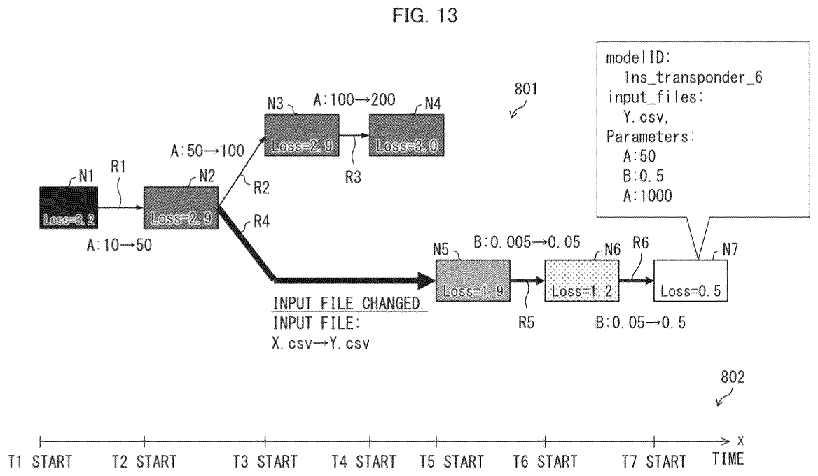

FIG. 13 illustrates display data 801 in which color densities of nodes and thicknesses of links determined by the above method are reflected. As illustrated in FIG. 13, the first node N1 is filled in black. However, as the loss value decreases (the performance is improved), the node N is displayed in a lighter color. As for the thickness of the links R, the link R4 which has a large decrease in loss value is displayed as a thick arrow. This display data is displayed on the display 70. That is, by tracing the nodes on a route having thick links on the display 70 in a direction in which the colors of the nodes gradually fade, it is easy to visually understand a process of constructing a target model L which process enhances the performance of the target model L.

Note that the output section 23 outputs display data in which the plurality of nodes including the node from which the branching is made are arranged in a predetermined direction so as to corresponding to the times at which the trials have been carried out, as illustrated in FIG. 13. In other words, in the display data, the plurality of nodes corresponding to the plurality of trials included in the first group of trials and the second group of trials are arranged in the predetermined direction in the order in which the trials have been carried out. For example, a coordinate system in which the x-axis corresponds to a direction representing a chronological order is defined in the display data, and the first nodes and the second nodes are positioned such that a relationship between (i) the x coordinates of the first nodes representing the first trials included in the first row and (ii) the x coordinates of the second nodes representing the second trials included in the second row indicates chronological orders between the first trials and the second trials. That is, the earlier a trial of a node N is carried out temporally, the further to the left in FIG. 13 the node N is located, and the later a trial of a node N is carried out temporally, the further to the right in FIG. 13 the node N is located. More specifically, trial start time of each trial T is indicated by a position on the left side of the rectangle of the node N, as indicated on a time axis 802. For example, from a positional relationship between the node N3 and the node N5, it can easily be recognized visually that the trial T3 included in one of the rows branched from the trial T2 is carried out temporally ahead of the trial T5 included in the other of the rows. By arranging the plurality of nodes N in a manner in which the chronological order of the plurality of nodes N is maintained, it is possible to make it easy to visually understand the chronological order in the process of constructing the target model L. Note that the time axis 802 need not be included in the display data 801.

Further, as illustrated in FIG. 13, the display data includes information indicative of the performance of an AI model obtained in each trial. The output section 23 outputs display data including information indicative of the performance of an AI model obtained in each trial. That is, a loss value is displayed in the rectangle of each node N of the display data 801. By thus displaying information indicative of the performance of the target model L, it is easy to confirm an improvement in performance in terms of a specific numerical value.

Further, as illustrated in FIG. 13, the display data includes a parameter used in each trial. The output section 23 outputs display data in which, among the parameters used in a preceding trial, at least a parameter changed in a subsequent trial is included. For example, in a lower position corresponding to the link R1 connecting the node N1 and the node N2 to each other, information “A: 10→50”, which indicates that the parameter A is changed from 10 to 50, is displayed. Further, in a lower position corresponding to the link R4, information “Input file changed. Input file: X.csv→Y.csv”, which indicates that the input file is changed from X.csv to Y.csv, is displayed. According to the above configuration, a parameter which has been changed is displayed. This makes it easy to visually understand which parameter affects a change in performance.

Further, as illustrated in FIG. 13, the model ID, the input file name, and the parameter value used in the final node N7 cannot be displayed inside the node N7 and therefore are displayed together outside the node N7. This is data representing the specifications of an ultimately constructed target model L. In the present example embodiment, the ultimately constructed target model L refers to a target model L having the best performance value. Thus, the ultimately constructed target model L is not necessarily an AI model that is tried last in time.

Further, only on the shortest route from the first trial T1 to the trial T7, at which the best result has been obtained, the colors of nodes and links may be changed. For example, in a case where the link information illustrated in FIG. 9 is obtained, the colors of all nodes (N1, N2, and N5 to N7) and all links (R1 and R4 to R6) passed, from the first-tried trial T1 to the best trial T7, are changed. Such emphasized display provides the effect of making it possible to easily track which parameter should be changed to what extent, in a case of conducting a similar experiment.

Further, the display data includes a node in a mode corresponding to a degree of improvement or degradation in the performance. For example, a node can be darker in color and greater in size as the degree of improvement in performance increases. Conversely, a node can be lighter in color and smaller in size as the degree of degradation in performance increases. Such emphasized display makes it easy to distinguish a node that has contributed to improved performance.

### (Other Examples of Emphasized Display)

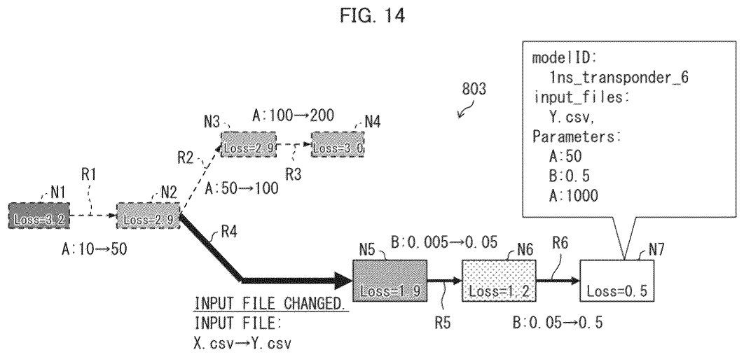

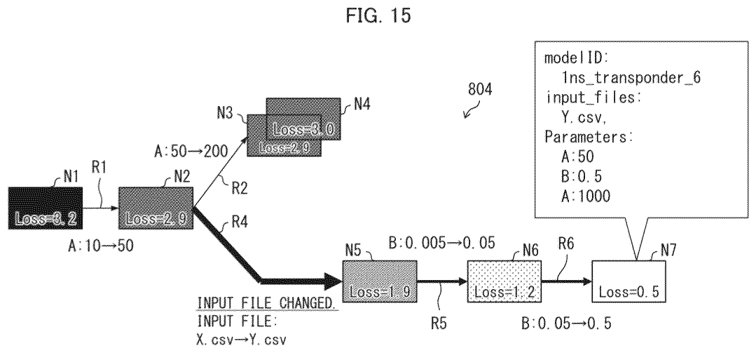

The following description will discuss, with reference to drawings, other examples of emphasized display of display data generated by the output section 23. FIG. 14 is display data 803 in accordance with another example aspect generated by the output section 23. In the display data 803, the output section 23 includes a plurality of nodes in the display data such that the plurality of nodes are provided in a virtual three-dimensional space such that a node representing an identified trial and node representing a preceding trial appear at respective different distances from a viewpoint in the three-dimensional space. Specifically, in FIG. 14, the nodes N1, N2, N3, and N4 are each displayed so as to appear at a distance further from the viewpoint than the other nodes N. The display data 803 is display data which simulates a state that would appear if the nodes N are arranged in a virtual three-dimensional space.

Specifically, the output section 23 causes a node N representing a trial with a relatively large degree of improvement in performance of the target model L to be displayed in a large size with a high color density, and causes a node N representing a trial with a relatively small degree of improvement in performance of the target model L to be displayed in a relatively small size with a low color density. In a three-dimensional space, an object at a position close to a viewpoint (the eye of a viewer) appears large and dark, and an object at a position far from the viewpoint appears small and light. The size and density of each node N can be derived as appropriate from the magnitude of the loss value of that node N. By thus simulating a state that would appear if the nodes N were arranged in a virtual three-dimensional space, it is possible to make it easy to visually understand a process of improving the performance of the target model L.

FIG. 15 is display data 804 in accordance with another example aspect generated by the output section 23. The display data 804 includes a node representing an identified trial and a node representing a preceding trial in a mode in which these nodes overlap each other at least partially, in a case where a difference between the performance of an AI model obtained from the identified trial and the performance of an AI model obtained from the preceding trial is not more than a predetermined threshold. The output section 23 outputs the display data 804.

For example, the user sets a threshold of 0.2 to a difference in loss value between consecutive nodes. As illustrated in FIG. 15, since a difference in loss value between the node N3 and the node N4 is 0.1, the node N3 and the node N4 are displayed so as to partially overlap with each other. This makes it possible to easily understand that nodes displayed so as to overlap with each other do not have a great improvement in performance therebetween. Note that a difference in loss value between the node N2 and the node N3 is 0, which is smaller than the threshold, but the node N2 is a node which branches. As such, the node N2 and the node N3 are not displayed so as to overlap each other.

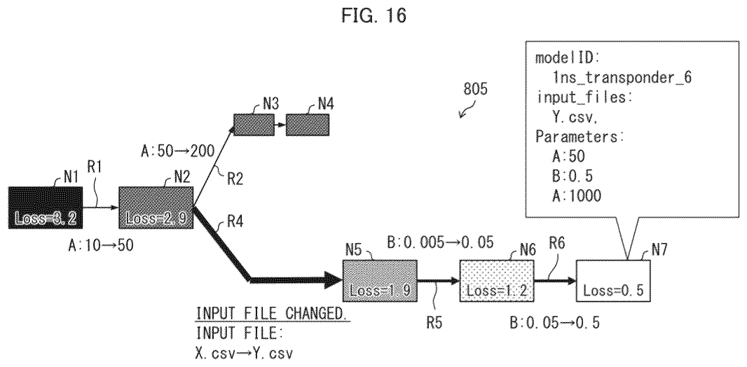

FIG. 16 is display data 805 in accordance with another example aspect generated by the output section 23. In the display data 805, in a case where a difference in loss value between consecutive nodes is smaller than a predetermined threshold, display of the consecutive nodes is made subtle. Specifically, the predetermined threshold is 0.2, and, as illustrated in FIG. 16, the node N3 and the node N4, between which a difference in loss value is 0.1, are reduced in size in comparison to the other nodes, and information pertaining to changes in loss value and parameter of the node N3 and the node N4 is omitted. Thus, the node N3 and the node N4 are less conspicuous than the other nodes. This makes it easy to understand visually that the trials indicated by these nodes did not contribute to improving the performance of the target model L. Note that the node N2 is a branching node, so that the display of the node N2 is not simplified.

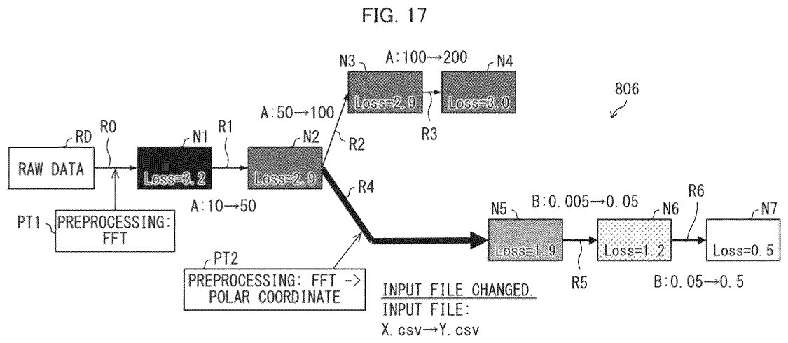

FIG. 17 is display data 806 in accordance with another example aspect generated by the output section 23. In the display data 806, preprocessing information pertaining to what kind of preprocessing generated the input data is displayed. For example, the user adds a preprocessing method for raw data to the input information 100. Thus, information of a preprocessing method is also added to the output information 200. The output section 23 causes this preprocessing information to be displayed as display data so as to be associated with the link R.

More specifically, in the display data 806, the node RD of raw data is displayed and is connected to the node N1 by a link R0. To the link R0, a display box PT1 for preprocessing information is displayed, and “preprocessing: FFT”, which indicates that the preprocessing method is fast Fourier transform (FFT), is displayed in the display box PT1. Further, a display box PT2 is added to a link R4 from the node N2 to the node N5, and “preprocessing: FFT→polar coordinate”, which indicates that the input data used was changed to data obtained by subjecting raw data to polar coordinate transform, is displayed in the display box PT2.

By thus adding a preprocessing method to the display data in a case where the loss value varies depending on the method of preprocessing raw data, it is possible to make it easy to understand visually that a change in loss value is an effect of a change of the preprocessing method.

### (Effects of Information Processing Apparatus 4)

As described above, in the information processing apparatus 4 in accordance with the present example embodiment, the inference section 22 identifies, among the plurality of trials, a trial in which performance of the AI model has improved or degraded in comparison to a preceding trial having the association with the trial. Further, a configuration is employed in which the output section 23 outputs (i) a node representing the identified trial and/or (ii) a link connecting the node and a node representing the preceding trial to each other, in a mode different from that of other node(s) or other link(s). Therefore, the information processing apparatus 4 in accordance with the present example embodiment can provide, in addition to the effects of the information processing apparatuses 1 and 2 in accordance with the first and second example embodiments, an effect of making it easy to visually understand, by tracing nodes and links displayed in a different mode(s), the process of constructing a target model which process enhances the performance of the target model.

### [Variation]

Note that in the second and third example embodiments described above, the input information 100 may include other data in place of all or part of the input data 101, the parameter data 102, the model ID 103, and the tag data 104 or in addition to the input data 101, the parameter data 102, the model ID 103, and the tag data 104. The output information 200 may include other data in place of all or part of the loss value 201, the abnormality degree 202, the trial time 203, the input data 101, the parameter data 102, the model ID 103, and the tag data 104 or in addition to the loss value 201, the abnormality degree 202, the trial time 203, the input data 101, the parameter data 102, the model ID 103, and the tag data 104. Information indicative of an evaluation result of the target model L in each trial may be other indicators in place of or in addition to one or both of the loss value 201 and the abnormality degree 202.

In the second and third example embodiments described above, extraction of the first row and the second row and identifying a branch point can be achieved by a technique which is not limited to the technique of referring to the first parameter, the second parameter, and the third parameter, but can be other techniques.

In the second and third example embodiments described above, nodes representing trials with improved or degraded performance and aspects of associated links are not limited to the aspects described above, but may be other aspects.

### [Software Implementation Example]

Some or all of the functions of the information processing apparatus 1, 2, or 4 may be realized by hardware such as an integrated circuit (IC chip) or may be alternatively realized by software.

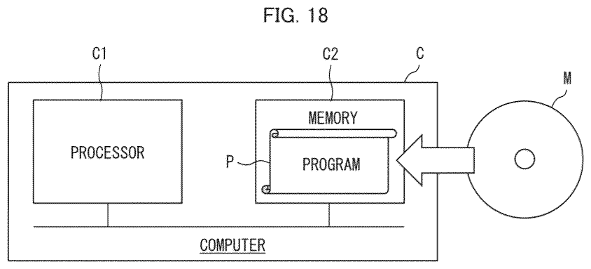

In the latter case, the information processing apparatus 1, 2, or 4 is realized by, for example, a computer that executes instructions of a program that is software realizing the foregoing functions. FIG. 18 illustrates an example of such a computer (hereinafter, referred to as “computer C”). The computer C includes at least one processor C1 and at least one memory C2. In the memory C2, a program P for causing the computer C to operate as the information processing apparatus 1, 2, or 4 is stored. In the computer C, the foregoing functions of the information processing apparatus 1, 2, or 4 can be realized by the processor C1 reading and executing the program P stored in the memory C2.

The processor C1 may be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 may be, for example, a flash memory, a hard disk drive (HDD), a solid state drive (SSD), or a combination thereof.

Note that the computer C may further include a random access memory (RAM) in which the program P is loaded when executed and/or in which various kinds of data are temporarily stored. The computer C may further include a communication interface for transmitting and receiving data to and from another apparatus. The computer C can further include an input-output interface for connecting input-output apparatuses such as a keyboard, a mouse, a display, and a printer.

The program P can also be recorded in a non-transitory tangible storage medium M from which the computer C can read the program P. Such a storage medium M may be, for example, a tape, a disk, a card, a semiconductor memory, a programmable logic circuit, or the like. The computer C can acquire the program P via the storage medium M. The program P can also be transmitted via a transmission medium. The transmission medium may be, for example, a communication network, a broadcast wave, or the like. The computer C can acquire the program P also via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

The whole or part of the example embodiments disclosed above can also be described as below. Note, however, that the present invention is not limited to the following example aspects.

### (Supplementary Note 1)

A model generation assistance apparatus, including: an acquisition means that acquires trial information including a parameter used in a trial in a process of constructing an AI model; an inference means that infers association between a plurality of trials on the basis of a difference between respective pieces of trial information of the plurality of trials; and an output means that outputs display data including (i) a plurality of nodes respectively representing the plurality of trials and (ii) a link representing the association.

The above configuration makes it possible to assist generation of a model by presenting a process of constructing a model in a more easily understandable manner.

### (Supplementary Note 2)

The model generation assistance apparatus according to supplementary note 1, wherein the plurality of nodes included in the display data are arranged in an order in which the plurality of trials have been carried out.

The above configuration makes it possible to easily understand a process over time of constructing a target model.

### (Supplementary Note 3)

The model generation assistance apparatus according to supplementary note 1 or 2, wherein: each piece of trial information includes a first parameter and a second parameter different from the first parameter; the inference means extracts, as a first group of trials associated with each other, a plurality of trials between which the first parameter is the same and the second parameter changes; and the output means outputs the display data including (i) a plurality of nodes representing the first group of trials and (ii) a link connecting the plurality of nodes representing the first group of trials to each other.

The above configuration makes it easy to understand a process of carrying out, in order to modify the target model, trials while changing the input information in a respective plurality of patterns.

### (Supplementary Note 4)

The model generation assistance apparatus according to supplementary note 3, wherein: each piece of trial information further includes a third parameter different from the first parameter and from the second parameter; the inference means extracts, as a second group of trials associated with each other, a plurality of trials between which each of the second parameter and the third parameter is the same and the first parameter changes, and identifies, as a branch point in the first group of trials, a trial in the first group of trials which trial has the same first parameter and the same second parameter as those of a temporally first trial in the second group of trials; and the output means outputs the display data in which nodes and a link representing the second group of trials (i) branch from a node representing the trial at the branch point among the plurality of nodes representing the first group of trials and (ii) are connected to each other.

The above configuration makes it easy to understand a process of carrying out, in order to modify the target model, trials while changing the input information in a respective plurality of patterns.

### (Supplementary Note 5)

The model generation assistance apparatus according to supplementary note 4, wherein in the display data, a plurality of nodes corresponding to a plurality of trials included in the first group of trials and the second group of trials are arranged in a predetermined direction in an order in which the plurality of trials have been carried out.

According to the above configuration, the plurality of nodes are arranged in a manner in which the chronological order of the plurality of nodes is maintained. This makes it easy to visually understand the chronological order in the process of constructing the target model.

### (Supplementary Note 6)

The model generation assistance apparatus according to any one of supplementary notes 1 to 5, wherein the display data includes information indicative of performance of the AI model obtained in each trial.

According to the above configuration, information indicative of the performance of a target model is displayed. This makes it easy to confirm an improvement in performance in terms of specific numerical values.

### (Supplementary Note 7)

The model generation assistance apparatus according to any one of supplementary notes 1 to 6, wherein the display data includes a parameter used in each trial.

According to the above configuration, a parameter which has been changed is displayed. This makes it easy to visually understand which parameter has resulted in a change in performance.

### (Supplementary Note 8)

The model generation assistance apparatus according to any one of supplementary notes 1 to 7, wherein: the inference means identifies, among the plurality of trials, a trial in which performance of the AI model has improved or degraded in comparison to a preceding trial having the association with the trial; and the output means outputs (i) a node representing the trial identified and/or (ii) a link connecting the node and a node representing the preceding trial to each other, in a mode different from that of another node or another link.

According to the above configuration, nodes and links displayed in a different mode(s) are traced. This makes it easy to visually understand the process of constructing a target model which process enhances the performance of the target model.

### (Supplementary Note 9)

The model generation assistance apparatus according to supplementary note 8, wherein the output means outputs at least one selected from the group consisting of: a color tone of the node representing the trial identified; a size of the node; a shape of the node; a color tone of the link; and a thickness of the link, in a mode different from that of another node or another link.

According to the configuration, a node and/or a link can be emphasized or made subtle by being caused to be different from another node/or another link.

### (Supplementary Note 10)

The model generation assistance apparatus according to supplementary note 8 or 9, wherein the display data includes a node in a mode corresponding to a degree of improvement or degradation in the performance.

The above configuration makes it easy to visually understand the process of improving the performance of a target model.

### (Supplementary Note 11)

The model generation assistance apparatus according to any one of supplementary notes 8 to 10, wherein in a case where a difference between performance of the AI model obtained in the trial identified and performance of the AI model obtained in the preceding trial is not more t than a predetermined threshold, the node representing the trial identified and the node representing the preceding trial are included in the display data in a mode in which the node representing the trial identified and the node representing the preceding trial overlap each other at least partially.

The above configuration makes it possible to easily understand that nodes displayed so as to overlap with each other do not have a great improvement in performance therebetween.

### (Supplementary Note 12)

A model generation assistance method, including: acquiring, by at least one processor, trial information including a parameter used in a trial in a process of constructing an AI model; inferring, by the at least one processor, association between a plurality of trials on the basis of a difference between respective pieces of trial information of the plurality of trials; and outputting, by the at least one processor, display data including (i) a plurality of nodes respectively representing the plurality of trials and (ii) a link representing the association.

The above configuration makes it possible to assist generation of a model by presenting a process of constructing a model in a more easily understandable manner.

### (Supplementary Note 13)

A program for causing a computer to carry out: an acquisition process of acquiring trial information including a parameter used in a trial in a process of constructing an AI model; an inference process of inferring association between a plurality of trials on the basis of a difference between respective pieces of trial information of the plurality of trials; and an output process of outputting display data including (i) a plurality of nodes respectively representing the plurality of trials and (ii) a link representing the association.

### [Additional Remark 3]

Further, the whole or part of the example embodiments disclosed above can also be expressed as below.

A model generation assistance apparatus, including at least one processor, the at least one processor carrying out: an acquisition process of acquiring trial information including a parameter used in a trial in a process of constructing an AI model; an inference process of inferring association between a plurality of trials on the basis of a difference between respective pieces of trial information of the plurality of trials; and an output process of outputting display data including (i) a plurality of nodes respectively representing the plurality of trials and (ii) a link representing the association.

Note that the model generation assistance apparatus may further include a memory, which may store therein a program for causing the at least one processor to carry out the acquisition process, the inference process, and the output process. The program may be stored in a computer-readable non-transitory tangible storage medium.

### REFERENCE SIGNS LIST

1, 2, 4: Information processing apparatus (model generation assistance apparatus)
3: Information processing apparatus (model generation assistance system)
11, 21: Acquisition section
12, 22: Inference section
13, 23: Output section
50: Model construction apparatus
60: Database
70: Display
100: Input information
101: Input data
102: Parameter data
200: Output information
250, 300: Trial information table
400: Inference data table
500: Display data
600: Color density table
700: Thickness table
801, 802, 803, 804, 805, 806: Display data

What is claimed is:

1. A model generation assistance apparatus comprising at least one processor, the at least one processor carrying out:
an acquisition process of acquiring trial information including a parameter used in a trial in a process of constructing an AI model;
an inference process of inferring association between a plurality of trials on the basis of a difference between respective pieces of trial information of the plurality of trials; and
an output process of outputting display data including (i) a plurality of nodes respectively representing the plurality of trials and (ii) a link representing the association.

2. The model generation assistance apparatus according to claim 1, wherein the plurality of nodes included in the display data are arranged in an order in which the plurality of trials have been carried out.

3. The model generation assistance apparatus according to, claim 1, wherein:
each piece of trial information includes a first parameter and a second parameter different from the first parameter;
in the inference process, the at least one processor extracts, as a first group of trials associated with each other, a plurality of trials between which the first parameter is the same and the second parameter changes; and
in the output process, the at least one processor outputs the display data including (i) a plurality of nodes representing the first group of trials and (ii) a link connecting the plurality of nodes representing the first group of trials to each other.

4. The model generation assistance apparatus according to claim 3, wherein:
each piece of trial information further includes a third parameter different from the first parameter and from the second parameter;
in the inference process, the at least one processor
extracts, as a second group of trials associated with each other, a plurality of trials between which each of the second parameter and the third parameter is the same and the first parameter changes, and
identifies, as a branch point in the first group of trials, a trial in the first group of trials which trial has the same first parameter and the same second parameter as those of a temporally first trial in the second group of trials; and
in the output process, the at least one processor
outputs the display data in which nodes and a link representing the second group of trials (i) branch from a node representing the trial at the branch point among the plurality of nodes representing the first group of trials and (ii) are connected to each other.

5. The model generation assistance apparatus according to claim 4, wherein in the display data, a plurality of nodes corresponding to a plurality of trials included in the first group of trials and the second group of trials are arranged in a predetermined direction in an order in which the plurality of trials have been carried out.

6. The model generation assistance apparatus according to claim 1, wherein the display data includes information indicative of performance of the AI model obtained in each trial.

7. The model generation assistance apparatus according to claim 1, wherein the display data includes a parameter used in each trial.

8. The model generation assistance apparatus according to claim 1, wherein:
in the inference process, the at least one processor identifies, among the plurality of trials, a trial in which performance of the AI model has improved or degraded in comparison to a preceding trial having the association with the trial; and
in the output process, the at least one processor outputs (i) a node representing the trial identified and/or (ii) a link connecting the node and a node representing the preceding trial to each other, in a mode different from that of another node or another link.

9. The model generation assistance apparatus according to claim 8, wherein in the output process, the at least one processor outputs at least one selected from the group consisting of: a color tone of the node representing the trial identified; a size of the node; a shape of the node; a color tone of the link; and a thickness of the link, in a mode different from that of another node or another link.

10. The model generation assistance apparatus according to claim 8, wherein the display data includes a node in a mode corresponding to a degree of improvement or degradation in the performance.

11. The model generation assistance apparatus according to claim 8, wherein in a case where a difference between performance of the AI model obtained in the trial identified and performance of the AI model obtained in the preceding trial is not more than a predetermined threshold, the node representing the trial identified and the node representing the preceding trial are included in the display data in a mode in which the node representing the trial identified and the node representing the preceding trial overlap each other at least partially.

12. A model generation assistance method, comprising:
acquiring, by at least one processor, trial information including a parameter used in a trial in a process of constructing an AI model;
inferring, by the at least one processor, association between a plurality of trials on the basis of a difference between respective pieces of trial information of the plurality of trials; and
outputting, by the at least one processor, display data including (i) a plurality of nodes respectively representing the plurality of trials and (ii) a link representing the association.

13. A non-transitory storage medium storing a program for causing a computer to carry out:
an acquisition process of acquiring trial information including a parameter used in a trial in a process of constructing an AI model;
an inference process of inferring association between a plurality of trials on the basis of a difference between respective pieces of trial information of the plurality of trials; and
an output process of outputting display data including (i) a plurality of nodes respectively representing the plurality of trials and (ii) a link representing the association.
